(19) United States
(12) Patent Application Publication
(10) Pub. No.: US 2020/0356070 A1
(43) Pub. Date: Nov. 12, 2020

(54) SYSTEM FOR REMOTE CONTROL OF PRODUCTION EQUIPMENT AND MANAGEMENT METHOD THEREFOR

(71) Applicant: UNOMIC CO., LTD., Busan (KR)

(72) Inventor: Hyung-cik YU, Busan (KR)

(73) Assignee: UNOMIC CO., LTD., Busan (KR)

(21) Appl. No.: 16/958,593

(22) PCT Filed: Dec. 29, 2017
(86) PCT No.: PCT/KR2017/015733

§ 371 Date: Jun. 26, 2020

(30) Foreign Application Priority Data
Dec. 29, 2017 (KR) 10-2017-0183637

(51) Int. Cl. G05B 19/4065; H04L 29/08; G05B 23/02

(52) U.S. Cl. CPC G05B 19/4065; G16Y 10/25; G05B 23/0218; H04L 67/125

(57) ABSTRACT

A system checks for abnormality in a machine tool and regardless of power interruption of the machine tool. A system for remote control of production equipment is installed in a management apparatus for the production equipment by receiving operational state information of a machine tool and transmitting the data thereof to a server. The system includes at least one sensor installed in the main body of the machine tool to collect operational information data thereof and transmit the same to the server. The sensor includes a dual power supply having a first external power source supplied with external power in communication with the machine tool and a second power source formed of a battery independent of the external power. A sensor communication network transmits the collected data to the server, whereby causes of failure may be judged by determining whether data communication with the server is executed.

### FIELD OF INVENTION

The present invention relates to checking whether there is abnormality in a management apparatus for a machine tool, more particularly, to a system for remote control of production equipment in order to prevent occurrence of failure in power sensor detection data due to power interruption of the machine tool itself, as well as a management method for the same.

### BACKGROUND OF INVENTION

In general, a machine tool includes a main shaft (or spindle) motor for receiving power from a power supply unit and for controlling movement of the tool, which is mounted on the motor, and a feed shaft motor for controlling movement of a table on which an object to be processed is placed. Further, the machine tool includes a lubrication pump, a hydraulic fluid pump, a hydraulic pump and an illumination lamp, each of which requires power consumption.

By notifying a user of power consumption in the machine tool through a monitoring device, the user may sense unnecessary power consumption through the amount of power consumption which is transmitted and thus may cut off the power determined as unnecessary standby power by controlling the power supply unit.

In addition, apparatuses related to production equipment to manage abnormality of power data in regard to such a machine tool are usually installed in the machine tool and receive driving power from the machine tool. That is, the apparatus related to production equipment is installed in the machine tool to collect diverse information from NC and then transmit the same to a server. At this time, when the power of the machine tool is cut off, the production equipment management apparatus does not receive electric power, whereby data transmission to the server becomes impossible. Therefore, the server cannot determine which one among various situations of impossible data collection is applied to the above status, hence not taking a proper measure.

Table 1 below shows various states.

TABLE 1
Case of data collection interruption
and corresponding states thereof

| Interruption of data collection | Data collection status (server) |
|---|---|
| Cut off power from machine tool | No data collected from production |
| | equipment related apparatus |
| Network blocking (production site) | No data collected from production |
| | equipment related apparatus |
| Network blocking (server) | No data collected from production |
| | equipment related apparatus |
| Abnormality of production equip- | No data collected from production |
| ment related apparatus itself | equipment related apparatus |

As shown in the above table, even though there are different causes for data transmission failure, for example, data transmission failure due to interruption of power supply to the related apparatus caused by power cut-off of the machine tool itself, data transmission failure due to power cut-off of the network at the production site although the machine tool is functioning normally, network blocking in the server itself, and data transmission failure due to abnormality of the production equipment related apparatus itself, the server could not collect any data in any of the above cases. Therefore, it could not be determined which one among the data transmission failures described above causes abnormality, hence inconveniently requiring manual checking of the machine tool.

### SUMMARY OF INVENTION

### Technical Problem to be Solved

Accordingly, the present disclosure has been proposed to overcome the aforementioned problems occurring in the prior art, and an object of the present invention is to provide a system for checking whether a machine tool has abnormality, which possibly collects data regardless of power interruption of the machine tool itself and allows transmission of the same to a server, as well as a management method for the same.

Further, it is another object of the present invention to provide a system for checking whether a machine tool has abnormality, which allows data collection from a management apparatus for production equipment to be independently performed so that a cause of failure in data collection information can be accurately identified, as well as a management method for the same.

### Technical Solution

According to technical configurations of the present invention to accomplish the above purposes of the present invention,
with regard to a management apparatus for production equipment which receives operational state information of a machine tool and then transmits data to a server, provided is a system for remote control of production equipment in the apparatus, which includes at least one sensor 200 provided in a main body of the machine tool to collect operational information data in real time and transmit the same to a server 300, wherein the sensor 200 includes: a dual power supply 210 comprising a first external power source 212 supplied with external power in communication with the machine tool and a second power source 214 composed of a battery independent of external power; and a sensor communication network 220 to transmit the collected data to the server 300 through wire or wirelessly, whereby causes of a failure may be judged by determining whether data communication with the server is executed or not.

Further, preferably, the dual power supply may supply power to a board by activating a switch according to the power source (selectively input among the first power source and the second power source). The sensor communication network may include a detection sensor to receive the operational state information of the machine tool, a convertor ADC, and a wired/wireless transmission unit for communicating with the server.

More preferably, when power is supplied by the first external power source, the sensor communication network may allow transmission of data from the detection sensor, which receives the operational state information of the machine tool, through wire by the wired/wireless transmission unit; otherwise, when power is supplied by the second source, the sensor communication network may allow wireless transmission of data from the detection sensor, which receives the operational state information of the machine tool, by the wired/wireless transmission unit.

Meanwhile, the present invention provides a management method for remote control of production equipment, which includes: determining whether power is supplied by the external power source to supply power to the machine tool or by the internal battery; when the power is supplied by the external power source, transmitting data from the detection sensor provided with the operational information of the machine tool through wire to the server; otherwise, when the power is supplied by the internal battery, wirelessly transmitting data from the detection sensor provided with the operational information of the machine tool, thereby determining whether the server is under data communication.

### Effect of Invention

As described above, the present invention can achieve efficient operation of equipment by independently acquiring individual information on operation of machinery equipment, which is not influenced by power operating environment of the machine tool itself, and transmitting the same to the server, so as to determine whether there is abnormality in proper time.

Further, the inventive system can be operated regardless of power cut-off of the machine tool itself, thereby maximizing a lifespan of the management apparatus for production equipment.

### BRIEF DESCRIPTION OF DRAWINGS

FIG. 1 is a conceptual diagram of data communication between a machine tool and a server according to the present invention.

FIG. 2 is a conceptual diagram of a sensor for data communication according to the present invention.

### DETAILED DESCRIPTION OF PREFERRED EMBODIMENTS OF INVENTION

Hereinafter, configurations and operations of embodiments of the present invention will be described in detail with reference to the accompanying drawings.

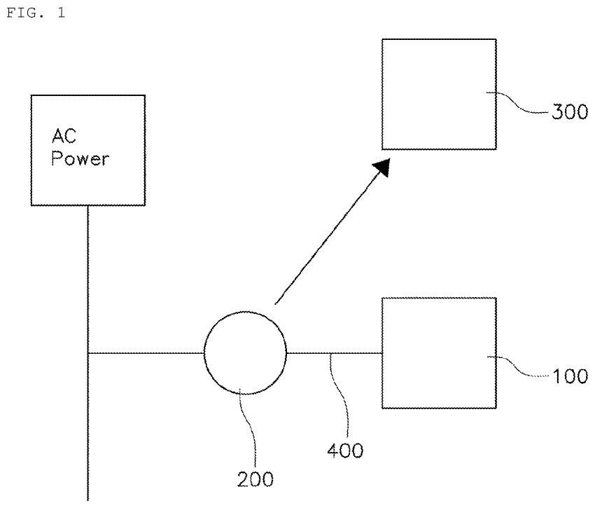

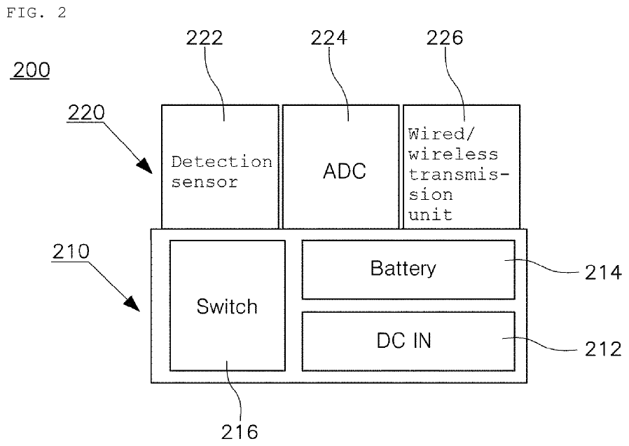

FIG. 1 is a conceptual diagram showing a pathway of data acquisition of a sensor 200 in a machine tool 100 according to the present invention, and FIG. 2 is a conceptual diagram illustrating a H/W structure of a sensor module according to the present invention.

As shown in the figures, a sensor 200 for collecting various operational information values, which are basically represented in a machine tool 100, may have a configuration of being connected to the machine tool 100 and a power line 400 to receive power, and further transmitting the received information to a server 300. Therefore, the sensor is shown as a single structure in view of outward appearance.

However, in an aspect of inner configuration, the sensor comprises a power supply 210 and a sensor communication network 220 for operation of the sensor 200, which are differently configured and separately activated. These will be described in detail below.

First, the power supply 210 will be described.

The power supply 210 may include a first external power source 212 electrically connected to external power for driving the machine tool 100, and a second power source composed of a battery 214. Further, the power supply 210 may be selectively operated by activation of a switch 216, thereby making it possible to accurately diagnose causes of failure such as inability to collect data by the sensor 200 due to power cut-off of the machine tool.

In other words, in case of normal operation, the sensor 200 is driven by the first power source 212 as a source of power supplied to the machine tool and may use a pathway to collect and transmit data to the server. If the first power source 212 is cut off, the power is supplied from the second power source 214 composed of a battery to thus conduct communication with the server. Such conversion of power source may be implemented by the switch 216. In this regard, the switch 216 may supply power to the board on the basis of the supplied power.

Further, as will be described later, when the power is supplied by the first power source 212, a communication network 220 in the sensor 200 may be connected to the server through wire and thus collect data by wire. This is substantially the same as the conventional one, and may be distinguishable from other communication, which will be described later.

Next, the sensor communication network 220 will be described. The sensor communication network 220 may include a detection sensor 222 for receiving operational information of the machine tool, an ADC 224 and a wired/wireless transmission unit 226 for receiving operation information of the machine tool.

First, the detection sensor 222 may collect information on activation of the machine tool such as power consumption and instantaneous power consumption due to the activation of the machine tool, and the information may be converted by the ADC 224 and transmitted to the wired/wireless transmission unit 226.

The wired/wireless transmission unit 226 may communicate with the data server 300 through wire or wirelessly so as to transmit data thereto. This serves to accurately judge if data collection by the server 300 is impossible.

That is, as described above, according to the related art, there are different cases where data collection of the server 300 is impossible. Such cases may be classified into: first, self-failure of the machine tool; second, network blocking at a production site; third, network blocking at server; and fourth, self-failure of a management apparatus. In consideration of respective cases, data collection failure may be accurately diagnosed by changing a transmission method to transmit data from the communication network 224 to the server 300.

For this purpose, in a wired manner, a wired/wireless communication network 224 may communicate with the server 300 when the sensor 200 is supplied and activated with power from the first power source 212 of the machine tool 110, as the conventional case. In a wireless manner, communication may be wirelessly executed between the production site and a network of the server. The wireless communication may use various wireless communication modes such as Wi-Fi, ZigBee, Ethernet, etc. In the present invention, networking with the production site and using the server's own network are distinguishable and executed by different types of wireless communication. For example, networking with the production site may be conducted through Wi-Fi signals, whereas the server's own network may be used in the form of ZigBee, whereby both of these networks are distinguishable from each other.

As described above, with regard to communication with the server, the machine tool uses wired communication; the network in the production site uses first wireless communication; and the server's own network uses second wireless communication, respectively. Therefore, unsuccessful data collection can be checked in different communication modes to thus solve a problem immediately. Of course, in case of self-failure of the sensor 200, no data is transmitted and this problem can also be surely recognized.

Next, a process of activating the sensor according to the present invention will be described later.

In case of normal activation, power supplied from the power supply for operation of the machine tool 100 may be transmitted to the first power source 212 in the sensor 200 to execute normal operation. Then, data of the machine tool transmitted to the detection sensor 222 may be converted by the ADC 224 and transmitted to the wired/wireless transmission unit 226. At this time, the wired/wireless transmission unit 226 may transmit the data to the server by wire. The server may judge the data transmitted by wire, recognize the same as data received from the machine tool, and then conduct normal operation.

If power supplied to the machine tool is cut-off, power supply from the first external power source 212 of the sensor may be stopped and the sensor may detect the same. Thereafter, a battery as the second power source 214 may be driven by a switching motion of the switch 216. In this case, since the sensor 200 is normally activated by the battery but operation of the machine tool 100 is stopped, no data may be transmitted from the detection sensor 222 and no data may be further transmitted to the server by wire. As a result, the server 300 can immediately determine this state as abnormality due to power cut-off of the machine tool 100 and take a corresponding measure.

Meanwhile, when the machine tool is in normal operation, or communication with the server is impossible due to network failure at the production site or due to a failure of the server's own network, data communication is wirelessly executed between the sensor 200 and the server 300. In this case, since data transmission depends on the wireless communication mode, it is immediately determined whether the failure is network failure at the production site or failure of the server's own communication network, thereby taking a proper measure.

On the other hand, in the case of self-failure of the sensor, communication with the server is never executed even in either a wired mode or a wireless mode, and therefore, this case may be recognized as self-failure of the sensor 200 and proper measures may be taken.

As illustrated in the above description, power supply to the sensor 200 may be configured in a dual manner including external power and internal power, selective operation thereof may be ensured, and communication with the server may be configured in a dual mode of wired/wireless communication. Further, since the wireless communication includes different communication modes, it is possible to determine in time which device has failed and prevents data collection by the server, thereby quickly managing the situation.

Further, it can be understood that the system of the present invention is activated regardless of power interruption of the machine tool itself, thereby maximizing a lifespan of the management apparatus for production equipment.

Although the concrete embodiments of the present invention have been described in detail, it will be obviously understood by those skilled in the art that various modifications or alterations may be possible without departing from the spirit and scope of the present invention, which are as defined by the appended claims.

1. A system for remote control of production equipment, which is installed in a management apparatus for the production equipment to receive operational state information of a machine tool and transmit data to a server so as to manage the production equipment, comprising:
at least one sensor which is provided in a main body of the machine tool to collect operational information of the machine tool in real time and transmit the same to the server, wherein the at least one sensor includes:
a dual power supply including a first external power source supplied with external power in communication with the machine tool, and a second power source having a battery independent of the external power; and
a sensor communication network to transmit the collected data to the server through wire or wirelessly, whereby causes of a failure are judged by determining whether data communication with the server is executed or not.

2. The system according to claim 1, wherein the dual power supply supplies power to a board by activating a switch depending on the power source.

3. The system according to claim 1, wherein the sensor communication network includes:
a detection sensor to receive the operational state information of the machine tool;
a converter ADC; and
a wired/wireless transmission unit for communicating with the server.

4. The system according to claim 1, wherein the sensor communication network allows:
transmission of data from the detection sensor, which receives the operational state information of the machine tool, through wire by the wired/wireless transmission unit, when power is supplied by the first external power source; and
wireless transmission of data from the detection sensor, which receives the operational state information of the machine tool, by the wired/wireless transmission unit, when power is supplied by the second power source.

5. A management method for remote control of production equipment, comprising:
determining whether power is supplied by an external power source to supply power to the machine tool or by an internal battery;
when the power is supplied by the external power source, transmitting data from the detection sensor provided with the operational information of the machine tool to the server by wire; and
when the power is supplied by the internal battery, wirelessly transmitting data from the detection sensor provided with the operational information of the machine tool, thereby determining whether there is data communication of the server.

6. The system according to claim 2, wherein the sensor communication network allows:
transmission of data from the detection sensor, which receives the operational state information of the machine tool, through wire by the wired/wireless transmission unit, when power is supplied by the first external power source; and
wireless transmission of data from the detection sensor, which receives the operational state information of the machine tool, by the wired/wireless transmission unit, when power is supplied by the second power source.

7. The system according to claim 3, wherein the sensor communication network allows:
transmission of data from the detection sensor, which receives the operational state information of the machine tool, through wire by the wired/wireless transmission unit, when power is supplied by the first external power source; and
wireless transmission of data from the detection sensor, which receives the operational state information of the machine tool, by the wired/wireless transmission unit, when power is supplied by the second power source.
